(19) United States
(12) Patent Application Publication
(10) Pub. No.: US 2026/0322870 A1
(43) Pub. Date: Oct. 15, 2026

(54) METHOD, APPARATUS, DEVICE FOR MESSAGE COMMUNICATION AND STORAGE MEDIUM

(71) Applicants: Beijing Zitiao Network Technology Co., Ltd., Beijing (CN); Bytedance Technology Ltd., Grand Cayman (KY)

(72) Inventors: Mengjun ZHANG, Beijing (CN); Ximou CHENG, Beijing (CN); Qingjian JIAO, Beijing (CN); Meng XU, Beijing (CN); Zhimin HAN, Beijing (CN); Xiaochan WANG, Beijing (CN); Qiujian NIU, Beijing (CN); Jiancong LEI, Beijing (CN); Zhuochen GE, Los Angeles, CA (US)

(21) Appl. No.: 19/374,459

(22) Filed: Oct. 30, 2025

(30) Foreign Application Priority Data
Apr. 9, 2025 (CN) 202510443365.X

(51) Int. Cl. H04L 67/10

(52) U.S. Cl. CPC H04L 67/10

(57) ABSTRACT

A method, an apparatus, a device, and a storage medium for message communication are provided. The method includes: receiving, from an external device, a notification message of an application on a second client, where the external device has communication connections with the first client and the second client respectively; obtaining, based on the notification message, an application name of the application on the second client; and determining an output message of the first client based on the notification message and the application name of the application, where the output message is provided to the external device for outputting.

### CROSS-REFERENCE

The present application claims priority to Chinese Patent Application No. 202510443365.X, filed on Apr. 9, 2025 and entitled “METHOD, APPARATUS, DEVICE FOR MESSAGE COMMUNICATION AND STORAGE MEDIUM”, the entirety of which is incorporated herein by reference.

### TECHNICAL FIELD

Example embodiments of the present disclosure generally relate to the field of computers, and in particular, to a method, an apparatus, a device for message communication, and a storage medium.

### BACKGROUND

With the development of information technology, various electronic devices can provide people with various services in aspects such as work and daily life. For example, an electronic device may implement an output service of notification messages of applications in the electronic device through a connected external device. This enables a user to timely and conveniently learn notification messages of applications received by the electronic device.

### SUMMARY

In a first aspect of the present disclosure, a method of message communication is provided. The method comprises: receiving, from an external device, a notification message of an application on a second client, where the external device has communication connections with a first client and the second client respectively; obtaining, based on the notification message, an application name of the application on the second client; and determining an output message of the first client based on the notification message and the application name of the application, where the output message is provided to the external device for outputting.

In a second aspect of the present disclosure, a method of message communication is provided. The method comprises: in response to receiving a notification message of an application from a second client, sending the notification message to a first client, where an external device has communication connections with the first client and the second client respectively; in response to receiving a first request for the application from the first client, sending a second request to the second client to request to obtain an application name of the application, where the first request and the second request are both generated based on at least a portion of the notification message; and in response to receiving a second response comprising the application name of the application from the second client, sending a first response to the first client for the first request, where the first response at least comprises the application name.

In a third aspect of the present disclosure, an apparatus for message communication is provided. The apparatus comprises: a notification message reception module configured to receive, from an external device, a notification message of an application on a second client, where the external device has communication connections with a first client and the second client respectively; an application name obtaining module configured to obtain, based on the notification message, an application name of the application on the second client; and an output message determination module configured to determine an output message of the first client based on the notification message and the application name, where the output message is provided to the external device for outputting.

In a fourth aspect of the present disclosure, an apparatus for message communication is provided. The apparatus comprises: a notification message reception module configured to send, in response to receiving a notification message of an application from a second client, the notification message to a first client, where an external device has communication connections with the first client and the second client respectively; a request module configured to send, in response to receiving a first request for the application from the first client, a second request to the second client to request to obtain an application name of the application, where the first request and the second request are both generated based on at least a portion of the notification message; and an application name obtaining module configured to send, in response to receiving a second response comprising the application name of the application from the second client, a first response to the first request to the first client, where the first response at least comprises the application name.

In a fifth aspect of the present disclosure, an electronic device is provided. The electronic device comprises at least one processor and at least one memory coupled to the at least one processor and storing instructions for execution by the at least one processor. When executed by the at least one processor, the instructions cause the electronic device to perform the method of the first aspect or the second aspect.

In a sixth aspect of the present disclosure, a non-transitory computer-readable storage medium is provided. The non-transitory computer-readable storage medium stores a computer program that is executable by a processor to implement the method of the first aspect or the second aspect.

In a seventh aspect of the present disclosure, a computer program product is provided. The computer program product is tangibly stored in a computer storage medium and comprises computer-executable instructions which, when executed by a device, cause the device to perform the method of the first aspect or the second aspect.

It should be understood that the contents described in this section are not intended to define key or essential features of the embodiments of the present disclosure, nor to limit the scope of the present disclosure. Other features of the present disclosure will become readily apparent from the following description.

### BRIEF DESCRIPTION OF THE DRAWINGS

With reference to the accompanying drawings and the following detailed description, the above and other features, advantages, and aspects of the embodiments of the present disclosure will become more apparent. In the drawings, identical or similar reference numerals denote identical or similar elements, in which:

FIG. 1 illustrates a schematic diagram of an example environment in which embodiments of the present disclosure may be implemented;

FIG. 2 to FIG. 3 illustrate flow diagrams of signaling flows for message communication according to some embodiments of the present disclosure;

FIG. 4A to FIG. 4C illustrate example interfaces for message communication according to some embodiments of the present disclosure;

FIG. 5 to FIG. 6 illustrate flow diagrams of example processes for message communication according to some embodiments of the present disclosure;

FIG. 7 to FIG. 8 illustrate schematic structural block diagrams of example apparatuses for message communication according to some embodiments of the present disclosure; and

FIG. 9 illustrates a block diagram of an electronic device capable of implementing multiple embodiments of the present disclosure.

### DETAILED DESCRIPTION OF EMBODIMENTS

The embodiments of the present disclosure will be described in greater detail below with reference to the accompanying drawings. Although certain embodiments of the present disclosure are illustrated in the drawings, it should be understood that the present disclosure may be implemented in various forms and should not be construed as limited to the embodiments set forth herein. Instead, the provided embodiments are intended to enable a thorough and complete understanding of the present disclosure. It should be understood that the drawings and embodiments of the present disclosure are provided for example purposes only and are not intended to limit the scope of protection of the present disclosure.

It should be noted that any titles of sections or subsections provided herein are not limiting. Various embodiments are described throughout herein, and any type of embodiment may be included under any section or subsection. In addition, the embodiments described in any section or subsection may be combined in any manner with any other embodiments described in the same or different sections or subsections.

In the description of the embodiments of the present disclosure, the term “comprising” and similar expressions should be understood as open-ended inclusion, that is, “including but not limited to.” The term “based on” should be understood as “at least partially based on.” The terms “an embodiment” or “the embodiment” should be understood as “at least one embodiment.” The term “some embodiments” should be understood as “at least some embodiments.” Other explicit and implicit definitions may also be included below. The terms “first,” “second,” and the like may refer to different or identical objects. Other explicit and implicit definitions may also be included below.

The embodiments of the present disclosure may involve user data, data acquisition, and/or usage of data. These aspects comply with applicable laws, regulations, and relevant requirements. In the embodiments of the present disclosure, all data collection, acquisition, processing, handling, transmission, and use are performed on the premise that the user is informed and has given consent. Accordingly, when implementing the embodiments of the present disclosure, the types of data or information that may be involved, the scope of use, and the use scenarios should be disclosed to the user and authorization should be obtained from the user in an appropriate manner in accordance with relevant laws and regulations. The specific manner of disclosure and/or authorization may vary depending on actual conditions and application scenarios, and the scope of the present disclosure is not limited in this regard.

In the solutions described in this specification and the embodiments thereof, if the processing of personal information is involved, such processing will be conducted only on the basis of legitimate grounds (for example, obtaining the consent of the personal information subject, or when necessary for the performance of a contract), and will be carried out only within the prescribed or agreed scope. A user's refusal to provide personal information other than that necessary for basic functions will not affect the user's ability to use the basic functions.

As mentioned above, at present, an electronic device may be connected to an external device. A client (for example, an operating system) in the electronic device may send a received notification message of another client (for example, an application) installed in the electronic device to the external device via a communication link with the external device. The external device may output the notification message of the application received from the electronic device. However, depending on a constraint of the operating system of the electronic device, the notification message of the application received by the external device is usually configured to include specific notification content, and often lacks a name corresponding to a source corresponding to the notification message. In the absence of the name of the application, the user cannot intuitively identify the source of the notification message. In other words, the user cannot determine which application in the electronic device the message output by the external device comes from. As a result, the external device cannot output a complete notification message of the application or further process the notification message based on the complete notification message, resulting in a poor user experience.

The embodiments of the present disclosure propose an improved solution for message communication. The solution comprises: receiving, from an external device, a notification message of an application on a second client, where the external device has communication connections with a first client and the second client respectively; obtaining, based on the notification message, an application name of the application on the second client; and determining an output message of the first client based on the notification message and the application name of the application, where the output message is provided to the external device for outputting.

In this way, after receiving a notification message of an application, the embodiments of the present disclosure can obtain an application name of the application based on the notification message, and further determine an output message that includes the complete notification content of the application based on the notification message and the application name of the application. This facilitates timely provision of the output message indicating the source of the notification message to the user. As a result, the user can timely obtain, through the external device, the complete notification content of the application, particularly identify quickly from which application the notification content originates, thereby improving the user experience.

Various example implementations of the solution will be described in detail below with reference to the drawings.

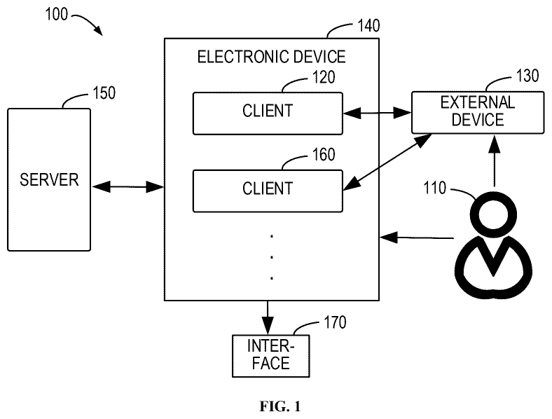

FIG. 1 illustrates a schematic diagram of an example environment 100 in which embodiments of the present disclosure may be implemented. As shown in FIG. 1, the example environment 100 may include a user 110, an external device 130, an electronic device 140, and a server 150.

In the example environment 100, the external device 130 may be a terminal device capable of being connected to the electronic device 140 through wireless or wired communication. The wireless communication may include, but is not limited to, cellular network communication, wireless local area network (WLAN) communication, Bluetooth communication, satellite communication, wireless personal area network (WPAN) communication, and the like. The wired communication may include, but is not limited to, USB communication, High-Definition Multimedia Interface (HDMI) communication, Video Graphics Array (VGA) communication, and the like. The external device 130 may include, but is not limited to: wearable terminal devices, personal digital assistants (PDAs), portable computers, desktop computers, image capture terminal devices such as digital cameras, game terminal devices, music storage and playback devices, vehicle-mounted wireless terminal devices, wireless endpoints, mobile stations, laptop embedded equipment (LEE), laptop-mounted equipment (LME), Universal Serial Bus (USB) dongles, smart devices, customer premise equipment (CPE) for wireless access, Internet of Things (IoT) devices, watches or other wearable devices, head-mounted displays (HMDs), vehicles, drones, medical devices and applications (for example, remote surgery), industrial devices and applications (for example, robots and/or other wireless devices operating in industrial and/or automated process chain environments), consumer electronic devices, and devices operating on commercial and/or industrial wireless networks, among others.

In the environment 100, the electronic device 140 may be any type of mobile terminal, fixed terminal, or portable terminal, including mobile phones, desktop computers, laptop computers, notebook computers, netbook computers, tablet computers, media computers, multimedia tablets, handheld computers, portable game terminals, VR/AR devices, personal communication system (PCS) devices, personal navigation devices, personal digital assistants (PDAs), audio/video players, digital cameras/camcorders, positioning devices, television receivers, radio receivers, e-book devices, game devices, or any combination of the foregoing, including accessories or peripherals thereof or any combination thereof. In some embodiments, the electronic device 140 may also be able to support any type of interface for the user 110, such as a “wearable” circuit.

In the environment 100, multiple clients may be installed on the electronic device 140, including a client 120, a client 160, and the like. Different clients may provide different services for the user 110. As an example, the client 120 may be an application capable of processing notification messages of applications in the electronic device 140, such as an application that summarizes notification messages of applications. The client 120 may be configured to acquire notification messages of other applications installed in the electronic device 140 and determine, based on the notification messages of the applications, messages for output through the external device 130, including playback messages or display messages. The client 160 may correspond to an operating system installed in the electronic device 140 to manage and allocate various resources of the electronic device 140 (for example, CPU, memory, hard disk, and other hardware resources). It should be understood that the client 160 may be any type of operating system. For example, the client 160 may be an iOS system, an Android system, or any other suitable terminal operating system. In the following description, for illustration, the client 160 (also referred to herein as the second client) will be taken as an iOS system installed on the electronic device 140 to discuss various embodiments of the present disclosure.

It should be understood that the above only provides examples of the sources of the client 120 and the client 160 (that is, both the client 120 and the client 160 are installed on the electronic device 140). In practical applications, the client 120 and the client 160 may be installed on any appropriate devices, respectively. For example, the client 120 may be installed on the external device 130, and the client 160 may be installed on the electronic device 140. In the following description, the embodiments of the present disclosure will be described by taking the client 120 (also referred to herein as the first client) as being installed on the electronic device 140 as an example.

In some embodiments, as the operating system of the electronic device 140, the client 160 may receive notification messages of various applications installed in the electronic device 140. The client 160 may provide system notifications within the electronic device 140 to notify notification messages of these application. In some embodiments, depending on user authorization, the client 160 may further send the notification messages corresponding to the applications to the external device 130, as will be described in detail below.

As another example, both the client 120 and the client 160 may be appropriate types of applications installed on the electronic device 140. The client 120 may be an application capable of processing notification messages of applications in the electronic device 140. For example, the client 120 may be configured to acquire notification messages of other applications installed in the electronic device 140 and determine output messages provided to the external device 130. The client 160 may be another application installed in the electronic device 140 that is different from the client 120, and may provide notification messages to another client according to user configuration or other predetermined configurations. For example, the client 160 may be an application that supports the user 110 in online shopping, and thus notification messages of the client 160 may include, but are not limited to, logistics messages, new product messages, and shopping activity messages.

It should be understood that the above only provides example clients and example notification messages. In practical applications, the solution of the present disclosure may be applied to any appropriate clients as needed. In addition, the notification messages of the applications may contain more, fewer, or other types of content, and the embodiments of the present disclosure are not limited in this regard.

In the environment 100 shown in FIG. 1, if the client corresponding to an application is in an active state, the electronic device 140 may present an interface 170 through the application.

In some embodiments, the server 150 communicates with the electronic device 140 to provide services for clients in the electronic device 140. The server 150 may be an independent physical server, a server cluster or distributed system formed by multiple physical servers, or a cloud server providing basic cloud computing services such as cloud services, cloud databases, cloud computing, cloud functions, cloud storage, network services, cloud communications, middleware services, domain name services, security services, content delivery networks, and big data and artificial intelligence platforms. For example, the server 150 may include computing systems/servers such as mainframes, edge computing nodes, or computing devices in a cloud environment. The server 150 may provide back-end services for the client in the electronic device 140 that summarizes and outputs notification messages of applications.

A communication connection may be established between the server 150 and the electronic device 140. The communication connection may be established through a wired or wireless manner. The communication connection may include, but is not limited to, a Bluetooth connection, a mobile network connection, a Universal Serial Bus (USB) connection, or a Wireless Fidelity (WiFi) connection, and the embodiments of the present disclosure are not limited in this regard. In the embodiments of the present disclosure, the server 150 and the electronic device 140 may perform signaling interactions through the communication connection between them.

It should be understood that the structures and functions of the respective elements in the environment 100 are described merely for illustrative purposes and are not intended to imply any limitation to the scope of the present disclosure.

The following will continue to describe some example embodiments of the present disclosure with reference to the drawings. For purposes of illustration and explanation, in the following description, the first client (hereinafter referred to as client 120) is taken as an application that processes notification messages of applications in the electronic device 140, and the second client (hereinafter referred to as client 160) is taken as an iOS system installed on the electronic device 140, to describe the embodiments of the present disclosure.

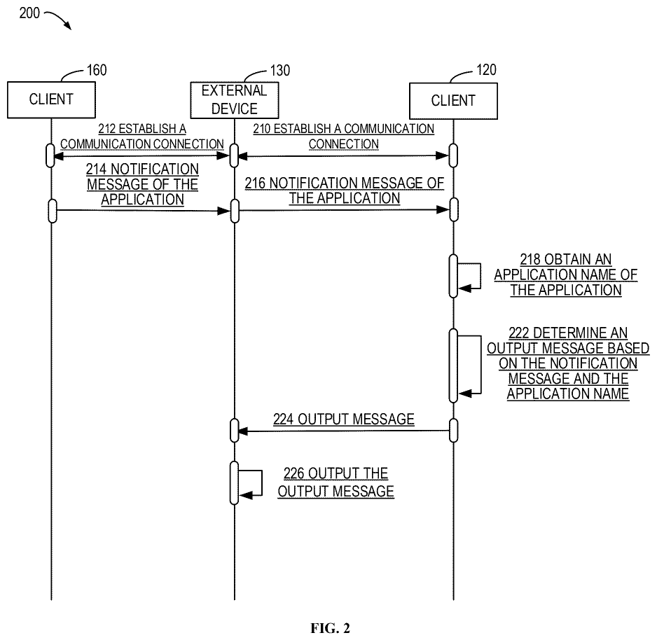

FIG. 2 illustrates a flow diagram of a signaling flow 200 for message communication according to some embodiments of the present disclosure. The signaling flow 200 may be implemented based on the environment 100 shown in FIG. 1. The signaling flow 200 illustrated in FIG. 2 will be described below with reference to FIG. 1.

As shown in FIG. 2, in the embodiments of the present disclosure, the external device 130 can establish (212) a communication connection with the client 160 in the electronic device 140 (hereinafter referred to as the “first communication connection”). The external device 130 can perform message communication through the first communication connection established with the client 160. The first communication connection may be a communication connection based on a near-field communication protocol. In some embodiments, different communication protocols may be used depending on the type of external device. For example, the external device 130 may be a Bluetooth device such as a wireless headset, a speaker, or a wired headset. The first communication connection may be a communication connection based on a Bluetooth protocol. As another example, the external device 130 may be a smart home device. The first communication connection may be a communication connection based on ZigBee. It should be understood that the above merely provides examples of external devices and the first communication connection. In practical applications, the solution of the present disclosure may be applied to any suitable external device using any suitable communication connection, and the embodiments of the present disclosure are not limited in this regard. In some embodiments, the messages communicated through the established first communication connection may include, but are not limited to, system notification messages of the client 160 and notification messages of applications in the electronic device 140.

In some embodiments, the client 160 may, in response to a request from the external device 130, send (214) notification messages of applications to the external device 130. The request of the external device 130 may be a subscription request for a communication service. In some embodiments, considering message security, the electronic device 140 will perform message sharing and interaction with the external device 130 only after the external device 130 connected to the electronic device 140 has subscribed to the related communication service. For example, the external device 130 may subscribe to a notification service indicating sharing and interaction of notification messages of applications in the electronic device 140 with the electronic device 140. After successful subscription, when the electronic device 140 receives a notification message of an application, it may send the notification message of the application to the external device 130 via the first communication connection to achieve message sharing.

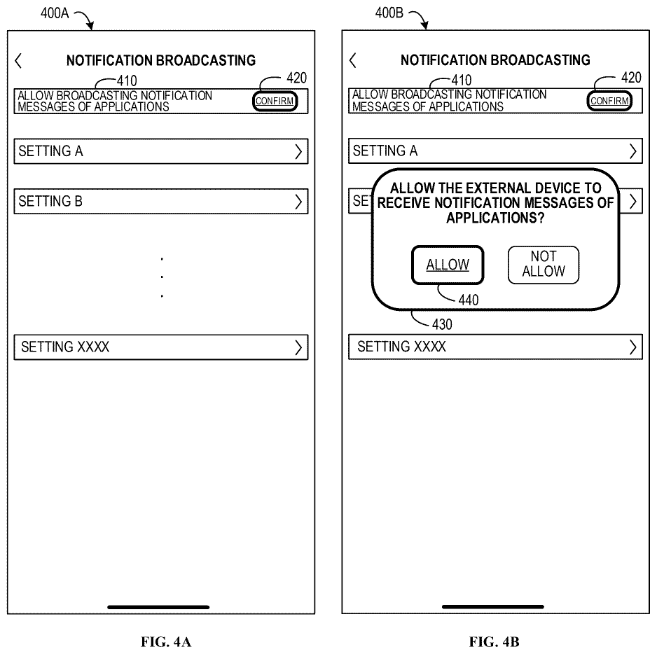

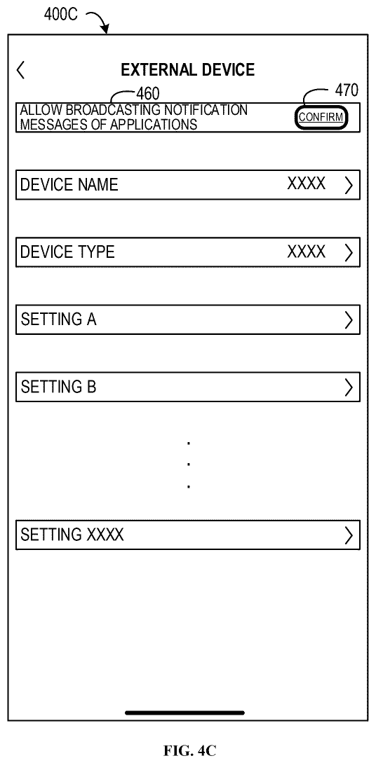

With reference to the example interfaces 400A to 400C shown in FIG. 4A to FIG. 4C, the generation process of the subscription request is described below. The interfaces 400A to 400C may be provided by the electronic device 140 shown in FIG. 1. It should be understood that the interfaces shown in the drawings are merely examples, and various interface designs may exist in practice. The graphical elements in the interfaces may have different layouts and visual representations, in which one or more of the elements may be omitted or replaced, and one or more additional elements may also be present. The embodiments of the present disclosure are not limited in this regard. In addition, the example embodiments below are mainly described with respect to the electronic device 140. It should be understood that the actions described with respect to the electronic device 140 may be performed by a client on the electronic device 140, or may be performed by the client in cooperation with its server (for example, the server 150). In some embodiments, in a scenario where the electronic device 140 operates in cooperation with its server (for example, the server 150), the electronic device 140 may request the server to provide messages to be presented, or the server 150 may, proactively or in response to operations of the electronic device 140, provide the messages to be presented to the electronic device 140.

In some embodiments, the interface 400A shown in FIG. 4A may indicate a setting interface for notification broadcasting in the electronic device 140. The interface 400A may present a setting item 410 indicating that the external device 130 is allowed to broadcast notification messages of applications, and multiple other setting items (for example, setting items A and B shown in FIG. 4A). If the user 110 intends to use the external device 130 connected to the electronic device 140 to broadcast notification messages of applications in the electronic device 140, the user may trigger a confirmation control 420 associated with the setting item 410.

In some embodiments, in response to the triggering of the confirmation control 420, the electronic device 140 may present an interface 400B as shown in FIG. 4B. A pop-up message 430 is presented in the interface 400B. The pop-up message 430 prompts the user 110 to confirm again whether to allow the external device 130 to receive notification messages of applications in the electronic device 140. If the electronic device 140 receives a selection of a control 440 via the interface 400B, and if at least one external device (including the external device 130) is connected to the electronic device 140, the electronic device 140 may present an interface 400C as shown in FIG. 4C. The interface 400C presents multiple setting items for the external device connected to the electronic device 140, including a setting item 460 indicating that sharing of application notification messages with the external device is allowed, a device name of the external device, a device type, and multiple other setting items (for example, setting items A and B shown in FIG. 4C). The user 110 may select a desired external device (for example, the external device 130) in the interface 400C, and may trigger a confirmation control 470 associated with the setting item 460. In response to the triggering of the confirmation control 470, the electronic device 140 may generate an enabling request for the communication service.

It should be understood that the above only provides example interfaces for generating the enabling request for the communication service. In practical applications, other appropriate methods may be provided for the user 110 as needed (for example, depending on the type of electronic device) to facilitate control over message sharing and interaction between the electronic device 140 and the external device 130.

Continuing with reference to FIG. 2, after successfully subscribing to the communication service, the external device 130 can receive notification messages of applications on the client 160 via the first communication connection. In some embodiments, the notification message of the application provided by the client 160 to the external device 130 at least includes an identifier (App ID) of the application. The identifier of the application may be a string consisting of at least one of letters, numbers, and underscores. The identifier of the application may be used to distinguish different applications installed on the electronic device 140.

In some embodiments, the notification message of the application may further include at least one of a notification title, notification body content, and a reception time of the notification message by the client 120. The notification title may be a summary of the notification body content (for example, extracted keywords from the notification body content), and may also indicate a module of the application involved in the notification message, a type of the notification message, and the like. It can be understood that the notification title generally consists of a small number of characters to facilitate quick browsing by the user.

In some embodiments, in order to enable the user to quickly recognize the notification message, the notification message of the application may be provided with a main title and a subtitle. For example, a notification message from a social communication application in the electronic device 140 may be “[Contact A], [Meeting Notice], [Notification Body],” where “Contact A” may be the main title of the notification message to indicate the sender of the notification message to the user 110, and “Meeting Notice” may indicate the type of the notification message.

In some embodiments, the notification body content may be a further explanation or supplement to the title. In other words, the notification body content may provide detailed information to the user 110. For example, the notification body content of a notification message from an online shopping application in the electronic device 140 may be “The product B purchased by you at time XXX is being transferred from location C to location D and is expected to be delivered to address XXXX on day XX.”

In some embodiments, the reception time of the notification message by the client 120 may be the time when the client 120 receives the notification message. The reception time of the notification message by the client 120 facilitates the user 110 to understand the timeliness of the notification message. The reception time of the notification message by the client 120 may be presented in the format of “year+month+day+specific time” or as “XX minutes/hours/days ago,” and the like.

Continuing with reference to FIG. 2, in the embodiments of the present disclosure, the external device 130 can establish (210) a communication connection with the client 120 in the electronic device 140 (hereinafter referred to as the “second communication connection”). The second communication connection may be a communication connection based on a private protocol. Through authorization by the electronic device 140, the external device 130 can perform message sharing with the client 120 in the electronic device 140 via the second communication connection. In some embodiments, the messages shared through the established second communication connection may include, but are not limited to, notification messages of other applications in the electronic device 140 and application names of other applications in the electronic device 140.

As further shown in FIG. 2, in the embodiments of the present disclosure, the client 120 can receive (216), via the second communication connection, the notification message of the application on the client 160 from the external device 130. To ensure the completeness of the outputted notification message of the application, the client 120 can obtain (218) the application name of the application based on the notification message of the application. To provide the notification message for the application to the user, the client 120 can determine (222) an output message based on the notification message of the application and the obtained application name. Furthermore, the client 120 sends (224) the output message to the external device 130, such that the external device 130 outputs (226) the output message. In this way, the user 110 can timely obtain the complete notification message of the application in the electronic device 140 through the external device 130.

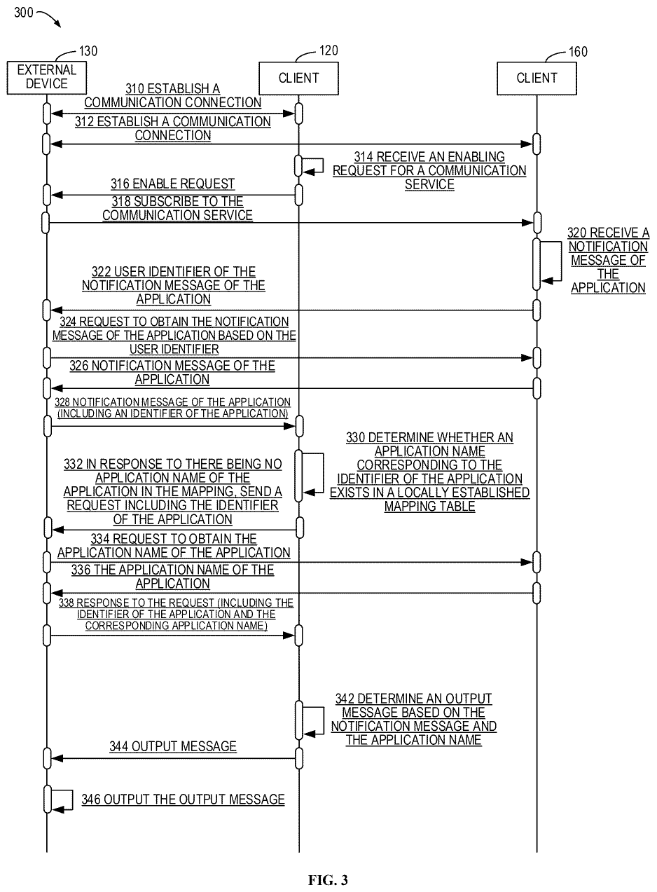

A process of message communication between the external device 130 and the electronic device 140 is described in detail below with reference to a signaling flow 300 for message communication according to some embodiments of the present disclosure shown in FIG. 3. As shown in FIG. 3, the external device 130 may establish (310) the second communication connection with the client 120 in the electronic device 140, and establish (312) the first communication connection with the client 160 in the electronic device 140, respectively. After receiving (314) the enabling request (referred to as the subscription request above) for the communication service, the client 120 may send (316) the enabling request for the communication service to the external device 130. The external device 130 may request to subscribe to (318) the communication service from the client 160 in response to the enabling request of the client 120. For example, the external device 130 may successfully subscribe to the communication service by requesting to subscribe to the communication service and features thereof from the client 160, requesting to subscribe to a data source, requesting to subscribe to a notification, etc. For the purpose of explanation, for the detailed description of the above process involved in FIG. 3, reference may be made to the description of FIG. 2, which is not repeated here.

Continuing to refer to FIG. 3, after the external device 130 successfully subscribes to the communication service, when the client 160 receives (320) the notification message of another application in the electronic device 140, a user identifier of the notification message of the application may be first sent (322) to the external device 130. Next, the external device 130 may request to obtain (324), from the client 160, the notification message of the application corresponding to the user identifier based on the user identifier of the notification message. The client 160 may send (326) the notification message of the application corresponding to the user identifier to the external device 130 in response to the request of the external device 130. Next, the external device 130 may send (328) the notification message of the application to the client 120 via the second communication connection with the client 120.

In some embodiments, after receiving the notification message including the identifier of the application, the client 120 may determine whether there is an application name matching the notification message of the application in the locally established mapping table. It should be noted that the mapping table established and stored locally by the client 120 may adopt a specific data structure. For example, the mapping table may adopt a key-value pair data structure. In some embodiments, the mapping table may include mapping relationships between identifiers of applications and application names of the applications. In this case, the terminal device 120 can determine a unique corresponding application name according to the identifier of the application. It should be understood that only an example mapping table applicable to the present disclosure is given here. In an actual application, the mapping table may be used to indicate a mapping relationship between any appropriate information, which is not limited in the embodiments of the present disclosure. It may be understood that the mapping table may be stored in the local storage space of the client 120 in any suitable storage manner, including but not limited to: a memory storage manner, a file storage manner, a database storage manner, a hybrid storage manner, etc.

With continued reference to FIG. 3, taking as an example a mapping table including a mapping relationship between identifiers of applications and application names of the applications, after the client 120 receives a notification message containing an identifier of an application, the client 120 may determine (330) whether an application name corresponding to the identifier of the application exists in the locally established mapping table. In some embodiments, if the client 120 determines that the locally established mapping table does not include the application name corresponding to the identifier of the application, the client 120 may send (332) a first request generated based on the identifier of the application to the external device 130. Then, based on the identifier of the application contained in the first request, the external device 130 sends, via the first communication connection, to the client 160, a second request generated based on the identifier of the application, to request to obtain (334) the application name corresponding to the identifier of the application. The client 160 sends (336), in response to the second request of the external device 130, via the first communication connection, the application name corresponding to the identifier of the application to the external device 130. Further, in response to the first request from the client 120, the external device 130, via the second communication connection, sends (338) to the client 120 the application name corresponding to the identifier of the application that is received from the client 160 and the identifier of the application. It can be understood that, to facilitate the client 160 in recognizing the response result of the external device 130 to the request, the external device 130 may, according to the data structure of the mapping table, determine the identifier of the application and the application name corresponding to the identifier of the application as a first response to the first request, and send the first response to the client 120.

In some embodiments, still taking as an example the mapping table including mapping relationships between identifiers of applications and application names of the applications, to improve the efficiency of message communication, after receiving from the external device 130 the identifier of the application and the application name corresponding to the identifier, the client 120 may update the locally stored mapping table. In other words, the client 120 may store the received identifier of the application and the application name corresponding to the identifier of the application into the mapping table. When the client 120 subsequently receives a notification message from the same application, it may obtain, based on the identifier of the application in the notification message, the application name corresponding to the identifier of the application from the mapping table. In this way, the client 120 can save the time cost of again requesting the external device 130 for obtaining the application name corresponding to the identifier of the application, thereby at least improving the efficiency of determining the notification message of the application.

Continuing with reference to FIG. 3, still taking as an example the mapping table including mapping relationships between identifiers of applications and application names of the applications, if the client 120 obtains an application name corresponding to an identifier of an application from the locally established mapping table, or requests the external device 130 to obtain the application name corresponding to the identifier of the application, the client 120 can determine (342) an output message based on the notification message of the application and the obtained application name corresponding to the identifier of the application. As an example, the output message may contain only a complete notification message related to the application. In some embodiments, the client 120 may combine the notification message of the application and the application name in a configured order to determine the complete notification message of the application. For example, the application name may be configured as information preceding in order, and the notification message of the application may be configured as subsequent information in order. In this way, the user 110 can first obtain the application name based on the output message output by the external device 130, so as to quickly understand the source of the notification message of the application and quickly determine the importance of the notification message of the application based on the application name. As another example, the output message may be a summary message of multiple complete notification messages for the application. After determining multiple complete notification messages, the client 120 may send the multiple complete notification messages to the server 150 that is in communication connection with the client 120. The server 150 may use some methods (for example, employing a machine learning model or using a configured summarization strategy, etc.) to summarize the multiple complete notification messages received from the client 120. After the summarization is completed, the server 150 may send the summary message to the client 120. The client 120 may then determine the summary message as the output message.

Furthermore, the client 120 may send (344) the determined output message to the external device 130 via the second communication connection. After receiving the output message of the client 120, the external device 130 may output (346) the output message in any suitable form. In some embodiments, the output message of the client 120 may be presented in a text form. The external device 130 may convert the output message presented in the text form into an output message presented in a media form such as audio. Then, the external device 130 may provide the output message presented in the media form to the user 110. The user 110 may timely obtain, through the external device 130, the notification message of the application in the electronic device 140, thereby improving the user experience.

In this way, the embodiments of the present disclosure can obtain the complete notification message of the application in the electronic device 140 through at least two communications between the external device 130 and the clients in the electronic device 140, and can timely present, through the external device 130, the output message containing the complete notification message of the application to the user 110. In this way, the user 110 can quickly obtain, through the external device 130, the complete notification message of the application in the electronic device 140. In particular, the user 110 can quickly determine, based on the application name included in the output message, the importance of the notification message of the application, thereby improving the usage experience of the user 110. In addition, the embodiments of the present disclosure further realize the establishment of the mapping table locally at the client in the electronic device 140, so as to store application names matching notification messages (for example, identifiers of applications) of the applications. In this way, when notification messages are obtained from the same application multiple times, the client of the electronic device 140 can quickly match the application name corresponding to the notification message of the application from the locally stored mapping table, thereby saving the time cost of again requesting the external device 130 to obtain the application name matching the notification message of the application, and improving the efficiency of message communication.

FIG. 5 is a flowchart of an example process 500 for message communication according to some embodiments of the present disclosure. The process 500 may be implemented at the client 120 in the electronic device 140. The process 500 is described below with reference to FIG. 1.

As shown in FIG. 5, in block 510, the client 120 receives, from the external device 130, a notification message of an application on the client 160, where the external device 130 has communication connections with the client 120 and the client 160 respectively.

In block 520, the client 120 obtains, based on the notification message, an application name of the application on the client 160.

In block 530, the client 120 determines an output message of the client 120 based on the notification message and the application name of the application, where the output message is provided to the external device 130 for outputting.

In some embodiments, the client 120 determines whether a mapping table of the client 120 includes an application name matching the notification message; in response to determining that the mapping table includes an application name matching the notification message, extracts the application name of the application from the mapping table; and in response to determining that the mapping table does not include an application name matching the notification message, obtains the application name of the application from the external device 130 based on the notification message.

In some embodiments, the notification message at least includes an identifier of the application, and the mapping table includes a mapping relationship between the identifier of the application and the application name.

In some embodiments, in response to determining that the mapping table includes an application name corresponding to the identifier of the application, the client 120 obtains, from the mapping table, the application name corresponding to the identifier of the application.

In this way, the client 120 can quickly match the application name corresponding to the identifier of the application from the local mapping table, thereby saving the time of requesting the external device 130 to obtain the application name corresponding to the identifier of the application, and improving the efficiency of message communication.

In some embodiments, in response to determining that the mapping table does not include an application name corresponding to the identifier of the application, the client 120 sends a first request to the external device 130, where the first request includes the identifier of the application; and receives, from the external device 130, a first response to the first request, where the first response includes the identifier of the application and the application name.

In this way, the client 120 can obtain a complete notification message of the application through two communications with the external device 130.

In some embodiments, the client 120 updates the mapping table based on the application name and the identifier of the application obtained from the external device 130.

In this way, when the client 120 obtains notification messages from the same application multiple times, the client 120 can quickly match, from the local mapping table, an application name corresponding to the identifier of the application contained in the notification message of the application, thereby saving the time cost of again requesting the external device 130 to obtain the application name corresponding to the identifier of the application, and improving the efficiency of message communication.

In some embodiments, the notification message further includes at least one of at least one notification title, notification body content, or a reception time of the notification message by the client 160. In this way, the user 110 can obtain multiple types of notification messages of applications through the external device 130, thereby enabling the user 110 to better evaluate the importance of the notification messages of the applications.

In some embodiments, the client 160 is installed on the electronic device 140, and the external device 130 has a communication connection with the electronic device 140.

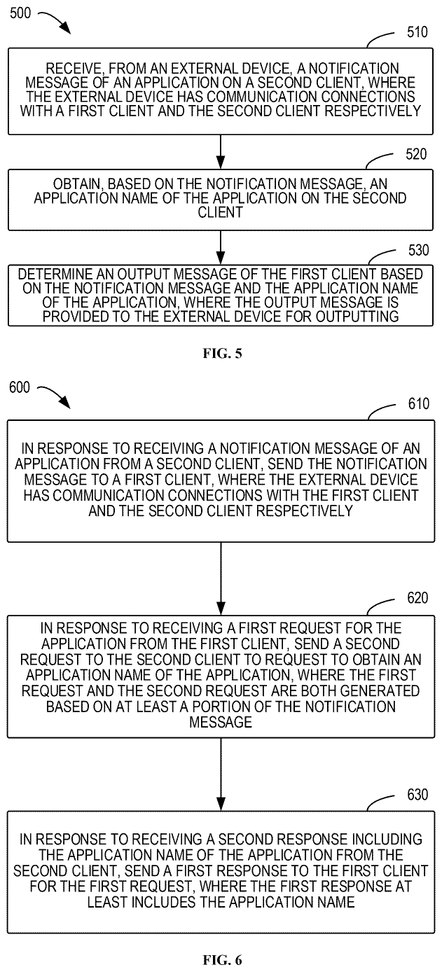

FIG. 6 illustrates a flow diagram of an example process 600 for message communication according to some embodiments of the present disclosure. The process 600 may be implemented at the external device 130 in the electronic device 140. The process 600 will be described below with reference to FIG. 1.

As shown in FIG. 6, in block 610, the external device 130, in response to receiving a notification message of an application from the client 160, sends the notification message to the client 120, where the external device 130 has communication connections with the client 120 and the client 160 respectively.

In block 620, the external device 130, in response to receiving a first request for the application from the client 120, sends a second request to the client 160 to request to obtain an application name of the application, where the first request and the second request are both generated based on at least a portion of the notification message.

In block 630, the external device 130, in response to receiving a second response including the application name of the application from the client 160, sends a first response to the client 120 for the first request, the first response at least including the application name.

In some embodiments, the notification message at least includes an identifier of the application, and both the first request and the second request include the identifier of the application, and the first response further includes the identifier of the application.

In some embodiments, the external device 130 receives an output message of the client 120 from the client 120, the output message being determined at least based on the notification message of the application and the application name of the application; and outputs the output message via the external device 130.

In this way, the external device 130 can timely present to the user 110 a complete notification message that at least includes the notification message of the application and the application name of the application.

In some embodiments, the external device 130 receives a user identifier corresponding to the notification message of the application from the client 160, and obtains the notification message of the application from the client 160 based on the user identifier. In this way, the security of the notification message of the application in the electronic device 140 can be improved.

In some embodiments, the external device 130, in response to receiving an enabling request for a communication service from the client 120, subscribes to the communication service of the client 160 based on the enabling request, where the communication service is configured to allow the external device 130 to obtain a notification message of an application on the client 160; and based on the subscription to the communication service, receives the notification message of the application from the client 160.

In this way, the external device 130 can implement sharing and interaction of notification messages in the electronic device 140.

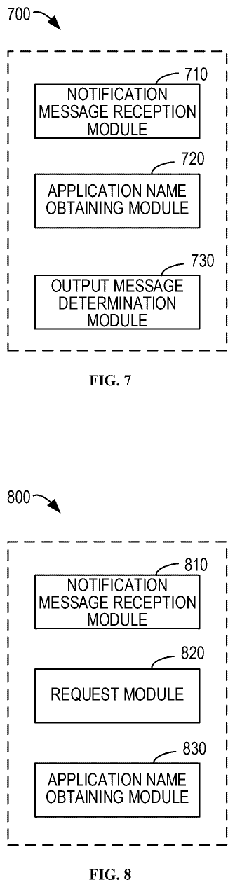

The embodiments of the present disclosure further provide a corresponding apparatus for implementing the above methods or processes. FIG. 7 illustrates a schematic structural block diagram of an example apparatus 700 for message communication according to some embodiments of the present disclosure. The apparatus 700 may be implemented as, or included in, the client 120 in the electronic device 140. Each module/component in the apparatus 700 may be implemented by hardware, software, firmware, or any combination thereof.

As shown in FIG. 7, the apparatus 700 includes: a notification message reception module 710 configured to enable the client 120 to receive, from the external device 130, a notification message of an application on the client 160, where the external device 130 has communication connections with the client 120 and the client 160 respectively; an application name obtaining module 720 configured to enable the client 120 to obtain, based on the notification message, an application name of the application on the client 160; and an output message determination module 730 configured to enable the client 120 to determine, based on the notification message and the application name, an output message of the client 120, where the output message is provided to the external device 130 for outputting.

In some embodiments, the application name obtaining module 720 may further be configured to determine whether a mapping table of the client 120 includes an application name matching the notification message; in response to determining that the mapping table includes an application name matching the notification message, extract the application name of the application from the mapping table; and in response to determining that the mapping table does not include an application name matching the notification message, obtain, from the external device 130 based on the notification message, the application name of the application.

In some embodiments, the notification message at least includes an identifier of the application, and the mapping table includes a mapping relationship between identifiers of applications and application names.

In some embodiments, the client 120, in response to determining that the mapping table includes an application name corresponding to the identifier of the application, obtains, from the mapping table, the application name corresponding to the identifier of the application.

In some embodiments, the application name obtaining module 720 may further be configured to, in response to determining that the mapping table does not include an application name corresponding to the identifier of the application, send a first request to the external device 130, where the first request includes the identifier of the application; and receive, from the external device 130, a first response to the first request, where the first response includes the identifier of the application and the application name.

In some embodiments, the application name obtaining module 720 may further be configured to update the mapping table based on the application name of the application and the identifier of the application obtained from the external device 130.

In some embodiments, the notification message further includes at least one of: at least one notification title, notification body content, or a reception time of the notification message by the client 160.

In some embodiments, the client 160 is installed on the electronic device 140, and the external device 130 has a communication connection with the electronic device 140.

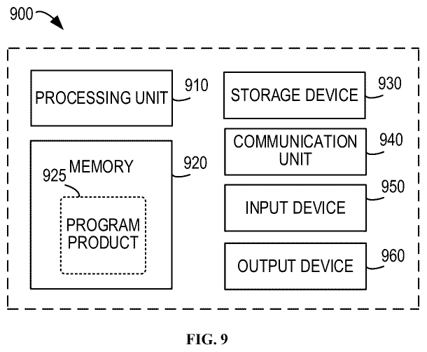

FIG. 8 illustrates a schematic structural block diagram of an example apparatus 800 for message communication according to some embodiments of the present disclosure. The apparatus 800 may be implemented as, or included in, the external device 130. Each module/component in the apparatus 800 may be implemented by hardware, software, firmware, or any combination thereof.

As shown in FIG. 8, the apparatus 800 includes: a notification message reception module 810 configured to, in response to receiving a notification message of an application from the client 160, send the notification message to the client 120, where the external device 130 has communication connections with the client 120 and the client 160 respectively; a request module 820 configured to, in response to receiving a first request for the application from the client 120, send a second request to the client 160 to request to obtain an application name of the application, where the first request and the second request are both generated based on at least a portion of the notification message; and an application name obtaining module 830 configured to, in response to receiving a second response including the application name of the application from the client 160, send a first response to the client 120 for the first request, the first response at least including the application name.

In some embodiments, the notification message at least includes an identifier of the application, and both the first request and the second request include the identifier of the application, and the first response further includes the identifier of the application.

In some embodiments, the apparatus 800 further includes: a message output module configured to receive, from the client 120, an output message of the client 120, the output message being determined at least based on the notification message of the application and the application name of the application; and to output the output message via the external device 130.

In some embodiments, the notification message reception module 810 is configured to receive, from the client 160, a user identifier corresponding to the notification message of the application, and to obtain the notification message of the application from the client 160 based on the user identifier.

In some embodiments, the notification message reception module 810 is configured to, in response to receiving an enabling request for a communication service from the client 120, subscribe to the communication service of the client 160 based on the enabling request, where the communication service is configured to allow the external device 130 to obtain notification messages of applications on the client 160; and based on the subscription to the communication service, receive the notification message of the application from the client 160.

As shown in FIG. 9, an electronic device 900 is in a form of a general electronic device. Components of the electronic device 900 may include but are not limited to at least one processor 910 or processing unit, a memory 920, a storage device 930, one or more communication units 940, one or more input devices 990, and one or more output devices 960. The processor 910 may be an physical or virtual processor, and can perform various processes based on a program stored in the memory 920. In a multi-processor system, a plurality of processors execute computer-executable instructions in parallel to improve a parallel processing capability of the electronic device 900.

The electronic device 900 typically includes a plurality of computer storage medium. Such medium may be any available medium accessible by the electronic device 900, including but not limited to volatile and non-volatile medium, and removable and non-removable medium. The memory 920 may be a volatile memory (for example, a register, a cache, a random access memory (RAM)), a non-volatile memory (for example, a read-only memory (ROM), an electrically erasable programmable read-only memory (EEPROM), a flash memory), or any combination thereof. The storage device 930 may be any removable or non-removable medium, and may include a machine-readable medium such as a flash drive, a disk, or any other medium, which may be used to store information and/or data and may be accessed within the electronic device 900.

The electronic device 900 may further include additional removable/non-removable, volatile/non-volatile memory medium. Although not shown in FIG. 9, a disk driver for reading from or writing into a removable, non-volatile disk (such as a “floppy disk”), and an optical disk driver for reading from or writing into a removable, non-volatile optical disk may be provided. In these cases, each driver may be connected to a bus (not shown) by one or more data medium interfaces. The memory 920 may include a computer program product 925 having one or more program modules configured to perform various methods or actions of various embodiments of the present disclosure.

The communication unit 940 enables communication with other electronic devices through the communication medium. Additionally, the functions of the components of the electronic device 900 may be implemented by a single computing cluster or a plurality of computing machines, which may communicate through a communication connection. Therefore, the electronic device 900 may use a logical connection with one or more other servers, a network personal computer (PC), or another network node to operate in a networked environment.

The input device 990 may be one or more input devices, such as a mouse, a keyboard, a tracking ball, etc. The output device 960 may be one or more output devices, such as a display, a speaker, a printer, etc. The electronic device 900 may further communicate with one or more external devices (not shown) such as a storage device and a display device as needed through the communication unit 940, communicate with one or more devices that enable the user to interact with the electronic device 900, or communicate with any devices (such as a network card and a modem) that enable the electronic device 900 to communicate with one or more other electronic devices. Such communication may be performed via input/output (I/O) interfaces (not shown).

According to an example implementation of the present disclosure, a computer-readable storage medium is provided, having computer-executable instructions stored thereon, where the computer-executable instructions are executed by a processor to implement the method described above. According to an example implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processor of a general-purpose computer, a special-purpose computer, or other programmable data processing apparatus to produce a machine, so that when these instructions are executed by the processor of the computer or other programmable data processing apparatus, an apparatus that implements the functions/actions specified in one or more blocks of the flowcharts and/or block diagrams is produced. These computer-readable program instructions may also be stored in a computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or other devices, so that a series of operation steps are performed on the computer, the another programmable data processing apparatus, or the other devices to produce a computer-implemented process, and thus, the instructions executed on the computer, the another programmable data processing apparatus, or the other devices implement the functions/actions specified in one or more blocks of the flowcharts and/or block diagrams.

The flowcharts and block diagrams in the figures show the possibly implemented architectures, functions, and operations of the system, the method, and the computer program product according to a plurality of implementations of the present disclosure. In this regard, each block in the flowchart or block diagram may represent a module, a program segment, or a portion of instructions, and the module, the program segment, or the portion of instructions contains one or more executable instructions for implementing the specified logical functions. In some alternative implementations, the functions marked in the blocks may also occur in an order different from that marked in the figures. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a special-purpose hardware-based system that executes specified functions or actions, or may be implemented by a combination of special-purpose hardware and computer instructions.

The implementations of the present disclosure have been described above, and the above description is illustrative, non-exhaustive, and not limited to the disclosed implementations. Without departing from the scope and gist of the illustrated implementations, many modifications and changes are obvious to those of ordinary skill in the art. The terms used herein are selected to best explain the principles of the implementations, the actual applications or improvements to the technologies in the market, or to enable other persons of ordinary skill in the art to understand the implementations disclosed herein.

1. A method of message communication implemented at a first client, the method comprising:
receiving, from an external device, a notification message of an application on a second client, wherein the external device has communication connections with the first client and the second client respectively;
obtaining, based on the notification message, an application name of the application on the second client; and
determining an output message of the first client based on the notification message and the application name of the application, wherein the output message is provided to the external device for outputting.

2. The method of claim 1, wherein obtaining the application name of the application comprises:
determining whether a mapping table of the first client comprises an application name matching the notification message;
in response to determining that the mapping table comprises the application name matching the notification message, extracting the application name of the application from the mapping table; and
in response to determining that the mapping table fails to comprise the application name matching the notification message, obtaining, from the external device, the application name of the application based on the notification message.

3. The method of claim 2, wherein the notification message at least comprises an identifier for the application, and the mapping table comprises a mapping relationship between an identifier for an application and an application name.

4. The method of claim 3, wherein extracting the application name of the application from the mapping table comprises:
in response to determining that the mapping table comprises an application name corresponding to the identifier for the application, obtaining, from the mapping table, the application name corresponding to the identifier for the application.

5. The method of claim 3, wherein obtaining, from the external device, the application name of the application comprises:
in response to determining that the mapping table fails to comprise an application name corresponding to the identifier for the application, sending a first request to the external device, wherein the first request comprises the identifier for the application; and
receiving, from the external device, a first response to the first request, wherein the first response comprises the identifier for the application and the application name.

6. The method of claim 5, further comprising:
updating the mapping table based on the application name of the application and the identifier for the application obtained from the external device.

7. The method of claim 1, wherein the notification message further comprises at least one of:
at least one notification title,
notification body content, or
a reception time of the notification message by the second client.

8. The method of claim 1, wherein the second client is installed on an electronic device, and the external device has a communication connection with the electronic device.

9. A method of message communication implemented at an external device, the method comprising:
in response to receiving a notification message of an application from a second client, sending the notification message to a first client, wherein the external device has communication connections with the first client and the second client respectively;
in response to receiving a first request for the application from the first client, sending a second request to the second client to request to obtain an application name of the application, wherein the first request and the second request are both generated based on at least a portion of the notification message; and
in response to receiving a second response comprising the application name of the application from the second client, sending a first response to the first client for the first request, wherein the first response at least comprises the application name.

10. The method of claim 9, wherein the notification message at least comprises an identifier for the application, and wherein the first request and the second request each comprise the identifier for the application, and the first response further comprises the identifier for the application.

11. The method of claim 9, further comprising:
receiving, from the first client, an output message of the first client, the output message being determined at least based on the notification message of the application and the application name of the application; and
outputting the output message via the external device.

12. The method of claim 9, wherein receiving the notification message of the application from the second client comprises:
receiving, from the second client, a user identifier corresponding to the notification message of the application; and
obtaining, from the second client, the notification message of the application based on the user identifier.

13. The method of claim 9, wherein receiving the notification message of the application from the second client comprises:
in response to receiving an enabling request for a communication service from the first client, subscribing to the communication service of the second client based on the enabling request, wherein the communication service is configured to allow the external device to obtain a notification message of an application on the second client; and
receiving, from the second client, the notification message of the application based on the subscription to the communication service.

14. An electronic device, comprising:
at least one processor; and
at least one memory coupled to the at least one processor and storing instructions for execution by the at least one processor, the instructions, when executed by the at least one processor, causing the electronic device to perform acts comprising:
receiving, from an external device, a notification message of an application on a second client, wherein the external device has communication connections with the first client and the second client respectively;
obtaining, based on the notification message, an application name of the application on the second client; and
determining an output message of the first client based on the notification message and the application name of the application, wherein the output message is provided to the external device for outputting.

15. The electronic device of claim 14, wherein obtaining the application name of the application comprises:
determining whether a mapping table of the first client comprises an application name matching the notification message;
in response to determining that the mapping table comprises the application name matching the notification message, extracting the application name of the application from the mapping table; and
in response to determining that the mapping table fails to comprise the application name matching the notification message, obtaining, from the external device, the application name of the application based on the notification message.

16. The electronic device of claim 15, wherein the notification message at least comprises an identifier for the application, and the mapping table comprises a mapping relationship between an identifier for an application and an application name.

17. The electronic device of claim 16, wherein extracting the application name of the application from the mapping table comprises:
in response to determining that the mapping table comprises an application name corresponding to the identifier for the application, obtaining, from the mapping table, the application name corresponding to the identifier for the application.

18. The electronic device of claim 16, wherein obtaining, from the external device, the application name of the application comprises:
in response to determining that the mapping table fails to comprise an application name corresponding to the identifier for the application, sending a first request to the external device, wherein the first request comprises the identifier for the application; and
receiving, from the external device, a first response to the first request, wherein the first response comprises the identifier for the application and the application name.

19. The electronic device of claim 18, wherein the acts further comprise:
updating the mapping table based on the application name of the application and the identifier for the application obtained from the external device.

20. The electronic device of claim 14, wherein the notification message further comprises at least one of:
at least one notification title,
notification body content, or
a reception time of the notification message by the second client.
